(19) United States
(12) Patent Application Publication
(10) Pub. No.: US 2018/0050263 A1
(43) Pub. Date: Feb. 22, 2018

(54) Game Communication Assembly and Method of Operating Same

(71) Applicants: Colt R. Correa, Shelby Township, MI (US); Amy L. Correa, Shelby Township, MI (US); Caleb S. Correa, Shelby Township, MI (US); Lydia M. Correa, Shelby Township, MI (US)

(72) Inventors: Colt R. Correa, Shelby Township, MI (US); Amy L. Correa, Shelby Township, MI (US); Caleb S. Correa, Shelby Township, MI (US); Lydia M. Correa, Shelby Township, MI (US)

(21) Appl. No.: 15/238,307

(22) Filed: Aug. 16, 2016

(51) Int. Cl. A63F 13/211; A63F 13/235; A63F 13/285; A63F 13/327

(52) U.S. Cl. CPC A63F 13/211; A63F 13/327; A63F 13/285; A63F 13/235

(57) ABSTRACT

A game communication assembly includes a sensor to sense a parameter and create a sensor signal based on that sensed event. An electronic control unit is electrically connected to the sensor to receive the sensor signal and to output a command signal. A transceiving unit is electrically connected to the electronic control unit to receive the command signal and to transmit the command signal remote from the game communication assembly.

### BACKGROUND ART

### Field of the Invention

The invention relates to an electronic game assembly. More particularly, the invention relates to wearable electronic game assembly capable of communicating with other wearable electronic game assemblies.

### Description of the Related Art

Very few games or gaming devices for children are designed to make the participants move about. Those that may encourage activity are not social because they are typically too big to move easily. In a day and age where the lure of electronics makes it difficult for a child to be active and social, there is a need to accomplish both.

### SUMMARY OF THE INVENTION

A game communication assembly includes a sensor to sense a parameter and create a sensor signal based on that sensed parameter. An electronic control unit is electrically connected to the sensor to receive the sensor signal and to output a command signal. A transceiving unit is electrically connected to the electronic control unit to receive the command signal and to transmit the command signal remote from the game communication assembly.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a top view of one embodiment of the invention;

FIG. 2 is a bottom view of the invention with a bottom plate removed;

FIG. 3 is a side view of the invention;

FIG. 4 is a top view of an alternative embodiment of the invention attached to an article of clothing;

FIG. 5 is a schematic view of the alternative embodiment of the invention showing various electronic components;

FIG. 6 is a logic chart of an operation of the invention;

FIGS. 7 through 10 shows various screen shots of games as viewed on a smart device paired with one embodiment of the invention; and

FIGS. 11a and 11b are side-by-side illustrations showing the invention operating in a virtual reality-styled game environment.

### DETAILED DESCRIPTION OF THE PREFERRED EMBODIMENT(S)

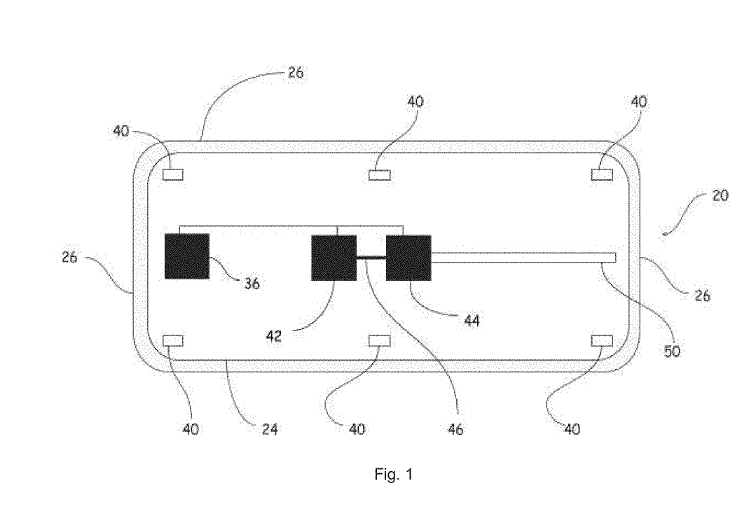

Referring to FIG. 1, one embodiment of the inventive assembly is generally indicated at 20. The assembly 20 is a game communication assembly or device 20. Generally, the game communication assembly 20 is of unitary construction and includes a housing 22 that covers all of the game communication assembly 20. The housing 22 is transparent allowing one to view all of the components inside the housing 22. It should be appreciated by those skilled in the art that the housing 22 may be translucent or opaque, depending on the desired aesthetic for a particular unit.

Inside the housing 22, the game communication assembly 20 includes a printed circuit board (PCB) 24. The PCB 24 is the structure to which all of the electronic components of the game communication assembly 20 will be connected. The PCB 24 extends out to the edges of the housing 22 and partially held in place by the side walls 26 that form a portion of the housing 22. Other structures formed with the housing 22 to hold the PCB 24 in place are not shown. While the invention is shown with a single PCB 24, one skilled in the art should appreciate that some configurations may include more than one PCB 24.

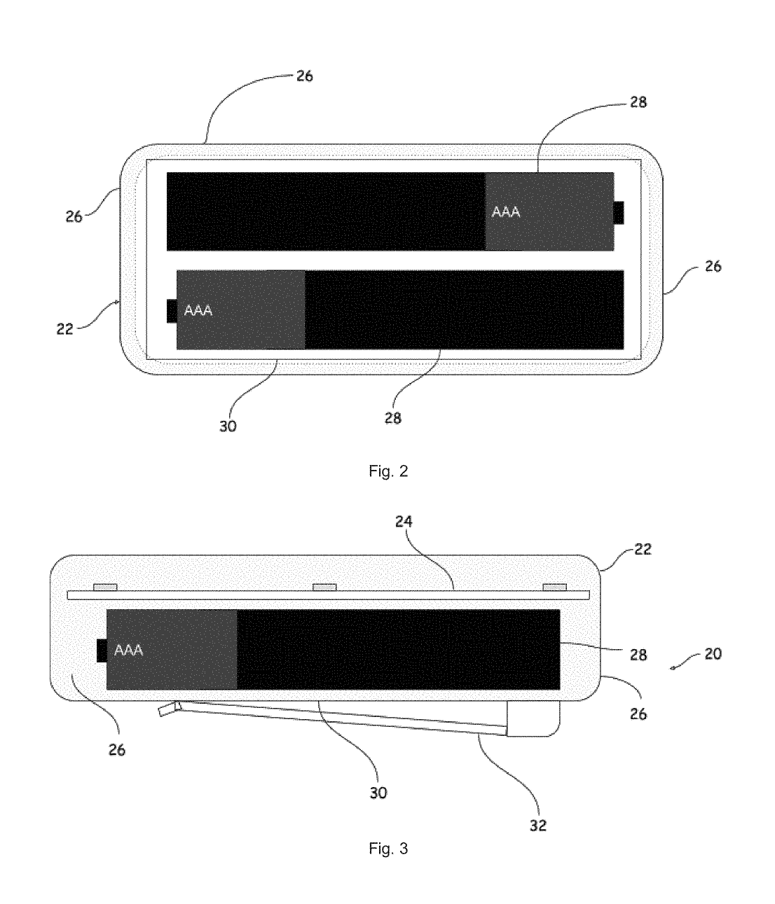

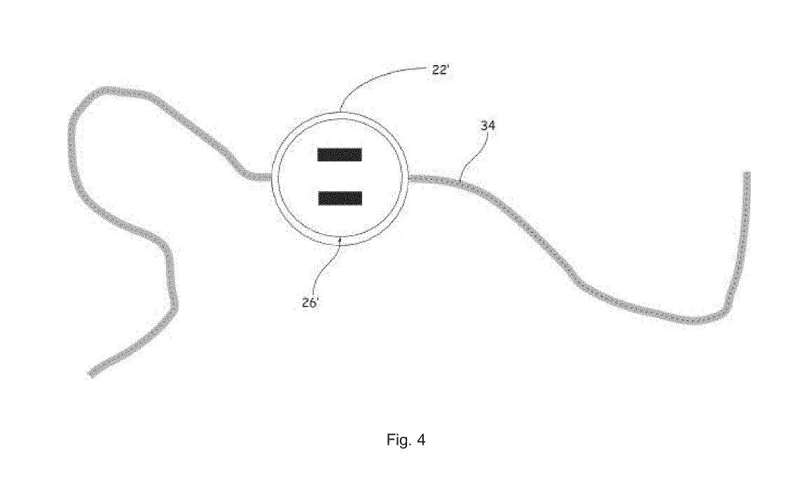

Referring to FIGS. 2 and 3, the game communication assembly 20 includes a power source 28 to power the components within the housing 22. In the embodiment shown, two AAA batteries 28 are housed within the housing 22 and have electrical connections to provide electrical power to the components mounted to the PCB 24. The batteries 28 may be a different size and they may be rechargeable. A charging port (not shown) may allow the batteries 28 (or cells) to be charged in situ.

The housing 22 includes a removable panel 30 to access the batteries 28 and the PCB 24. A chord 34 may extend out of the housing 22. The chord 34 may include a string of LEDs 35 that emit light in a programmed manner based on the mode in which the game communication assembly 20 is operating. The chord 34 may serve as a shoe lace for a shoe (not shown). It should be appreciated by those skilled in the art that the game communication assembly 20 could also be embedded in other articles of clothing such as shoes, gloves, hats, shirts, pants and the like.

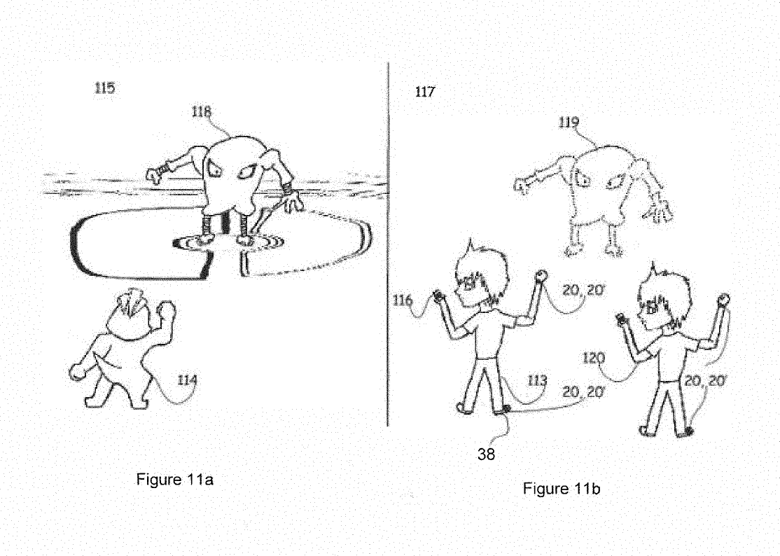

The housing 22 also includes a fastener 32 to fasten the game communication assembly 20 to an article of clothing 38, best seen in FIGS. 11a and 11b. It should be appreciated by those skilled in the art that the fastener may be a clip as shown, or any other device suitable for securing the game communication assembly 20 to the article of clothing 38, which may also be a shoe, a sock, a hat, a visor, a shirt, a belt and the like.

Referring back to FIG. 1, the PCB 24 is shown to have a voltage regulator 36. The voltage regulator 36 receives power from the power source 28 and provides power to the rest of the components on the PCB 24. LEDs 40 are illuminated based on the programming of the game communication assembly 20 and the game played by the user, both of which will be discussed in greater detail subsequently. In one embodiment, the voltage regulator 36 is produced by myRata, Inc. having part number LXDC2HN33A. The LEDs 40 may emit a single wavelength of light or multiple ranges of wavelengths and will be programmed appropriately for proper illumination.

A sensor 42 is electrically connected to the voltage regulator 36. The sensor 42 is a motion sensing device that may include any of the following: an accelerometer, a gyroscope and a magnetometer. The sensor 42 is able to determine how the game communication assembly 20 is moving, where it is in space and how fast it is going. In one embodiment, the motion sensing device 42 is an LSM9DS0TR 3D accelerometer, 3D gyroscope, 3D magnetometer produced by ST Microelectronics™.

Also receiving power from the voltage regulator 36 is an electronic control unit 44. The electronic control unit (ECU) 44 is electrically connected to the voltage regulator 36 and the motion sensing device 42. The ECU 44 communicates with the motion sensing device 42 using an I²C system 46. The ECU 44 may be a Nordic nrf52 System On Chip (SOC) that includes a 32-bit ARM processor and is capable of both ANT and BLE communications due to it having a transceiving unit built-in. ANT communications is a low power wireless technology that reduces the requirements for devices to communicate with each other. BLE (or Bluetooth® 4) is a low power version of Bluetooth®. ANT communications enable multiple game communication assemblies 20 to communicate with each other automatically when the game communication assemblies 20 are moved within the radio frequency range of each other. Connections or channels of data can be established using ANT communications without user input. BLE (or Bluetooth® 4) or standard Bluetooth® generally requires a user to pair devices together. In the present embodiment, BLE (or Bluetooth® 4) or standard Bluetooth® is used in the invention 20 to additionally communicate with a smart device because nearly all smart devices on the market such as iPhones, iPADS, and Android devices have BLE (or Bluetooth® 4) or standard Bluetooth® communications capability. And pairing a game communication assembly 20 with a smart device presumably need only be done once.

An RF antenna 50 is electrically connected to the ECU 44 and is used to receive and transmit signals to and from the ECU 44. The RF antenna 50 is shown as a single trace printed on the PCB 24. The RF antenna 50 may be located anywhere within the housing 22 to support convenient manufacture and/or maximize the gain of the RF antenna 50.

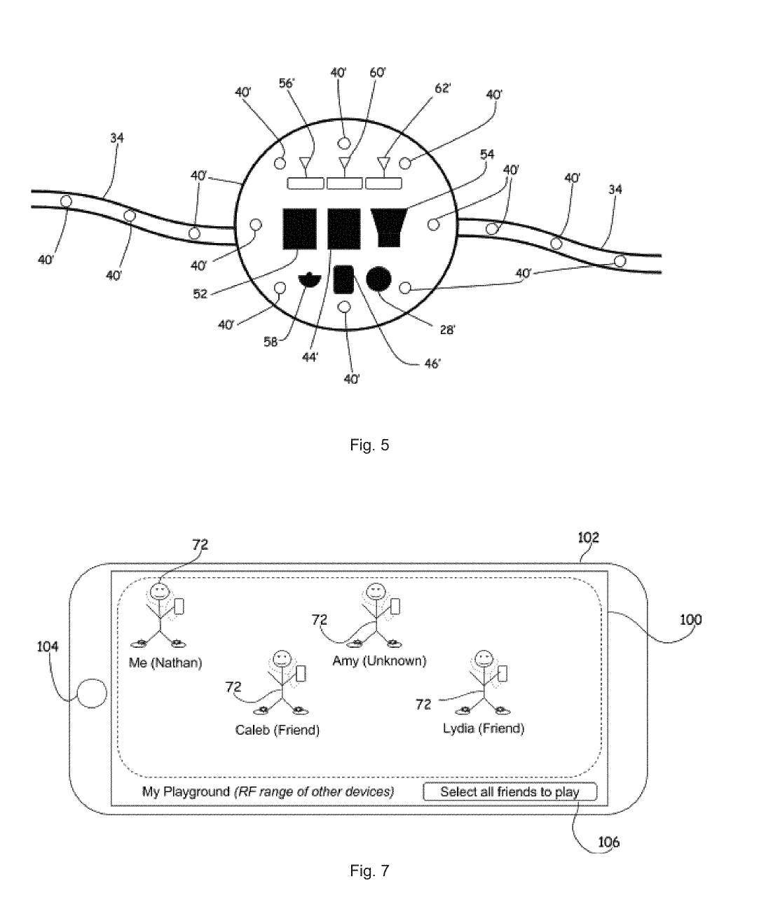

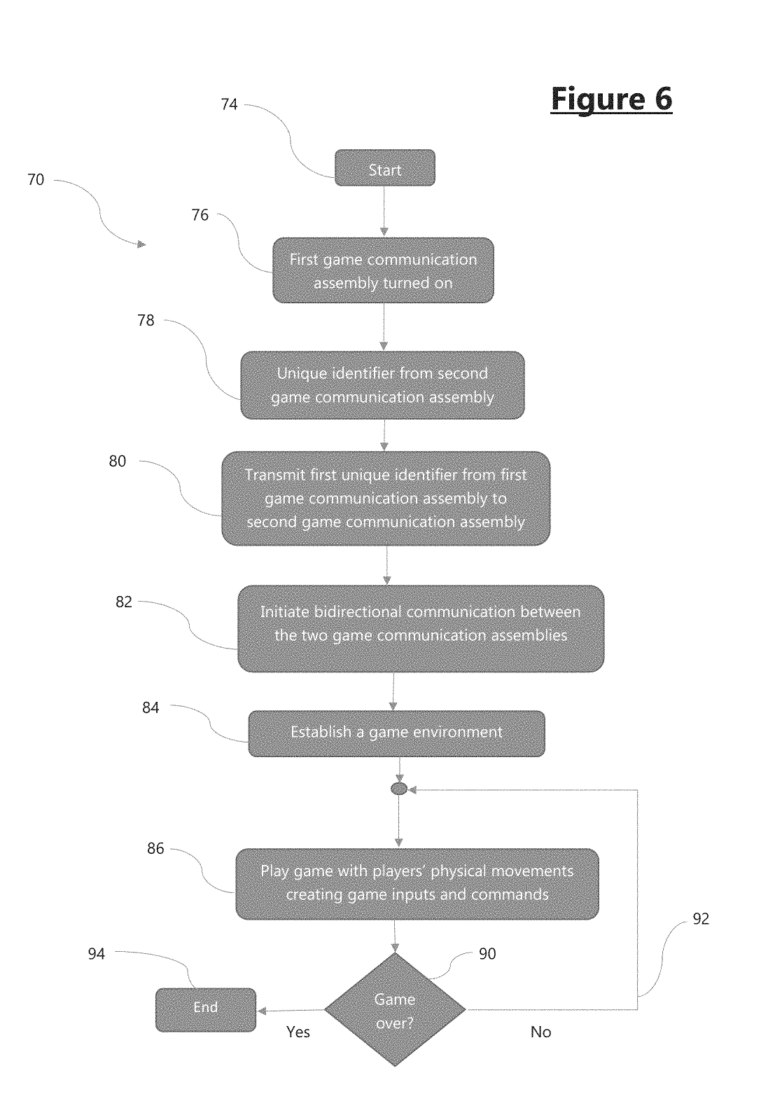

Referring to FIGS. 4 and 5, an alternative embodiment of the game communication assembly 20′ is generally shown with like primed numerals representing similar elements as in the embodiment shown in FIGS. 1 through 3. This embodiment 20′ differs from the prior embodiment 20 principally in its shape. Instead of four sidewalls 26, the housing 22 has a single cylindrical shaped sidewall 26′. The circular cylindrical shape of the sidewall 26′ gives the housing 22′ the shape of a puck. The puck-shaped housing 22′ is conducive to it being secured to various articles of clothing easier than others. It can also be held in a user's hand if that is desired, whereby the chord 34 extending out of the housing 22 can be used to fasten or tie the game communication assembly 20 to the hands, ankles, feet, or any other body part.

In this alternative embodiment, persistent memory 52 is used to store programs, track game results and store preference of the user. A speaker 54 is capable of producing any type of noise, sound, or voice that is required to assist the user in playing the chosen game. An RF antenna 56 provides RF communications using ANT protocol allows the game communication assembly 20′ to communicate between peer game communication assemblies 20, 20′ nearby. A heptic feedback device 58 may produce a vibration or other type of motion to allow the user to feel when the game communication assembly 20′ is signaling the user. Likewise, the game communication assembly 20′ may generate a sound from the speaker 54 to alert the user. A second RF antenna 60 for BLE provides communications for the host game communication assemblies 20′. A WiFi antenna 62 provides additional communication capabilities between multiple host game communication assemblies 20′. All of these devices that are used to communicate with smart devices and other game communications assemblies 20, 20′ are collectively referred to as a transceiving unit.

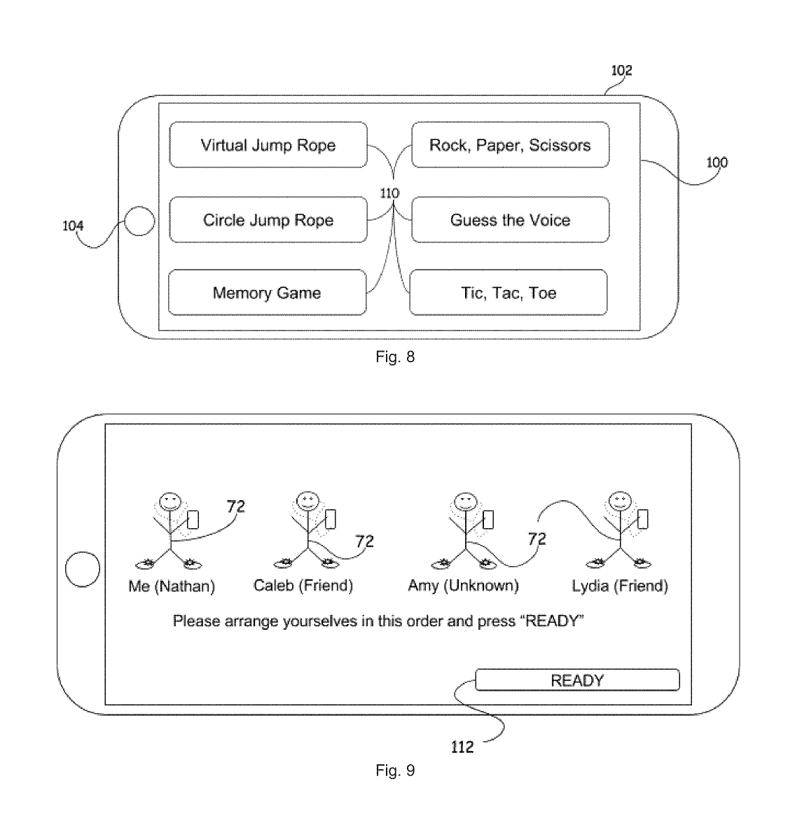

Referring now to FIG. 6, a method of operation is generally indicated at 70. The method 70 coordinates a game for a plurality of players 72 (shown in subsequent Figures) that are wearing at least one game communication assembly 20, 20′. In the Figures, each user is shown to be wearing a game communication assembly 20, 20′ on each shoe.

The method 70 begins at 74. A first game communication assembly 20, 20′ is turned on at 76. A unique identifier is received from a second game communication assembly 20, 20′ when one of the plurality of players 72 is in range of the first game communication assembly 20, 20′ at 78. The first game communication assembly 20,20′ then transmits it first unique identifier to the second game communication assembly at 80 to initiate bidirectional communication at 82. A game environment is established for the first and second game communication assemblies 20, 20′ for which any number of a plurality of players may join to play at 84. The game is commenced and played with each of the users or players 72 using body movements to create inputs and/or game commands at 86. It is then determined at 90 whether the game is over. If not, the game loops back at 92 and continues to receive inputs and commands from players 72 that were created out of the physical motion or movement of the players 72 to progress the game. If not, the game method 70 ends at 94.

As stated above, all the while a game is being played, new players 72 that come into a location where the game is being played may join the game, provided there is room for the player 72 within the game and it makes sense to add a player 72 at that juncture of the game.

For the games to work, the input values and the commands form one of the plurality of game communication assemblies 20, 20′ must be synced across all of the game communication assemblies 20, 20′ in real time such that any one of the plurality of players 72 may leave the game without affecting any remaining players 72 of the plurality of players 72 from completing the game. Not only is it important for completing the game, it is important for all of the plurality of players 72 to be on the same page and playing the same game at the same time. As stated above, it is important to sync all of the game communication assemblies 20, 20′ in a game so that the departure of one of the game communication assemblies 20, 20′ will minimally affect the game currently being played.

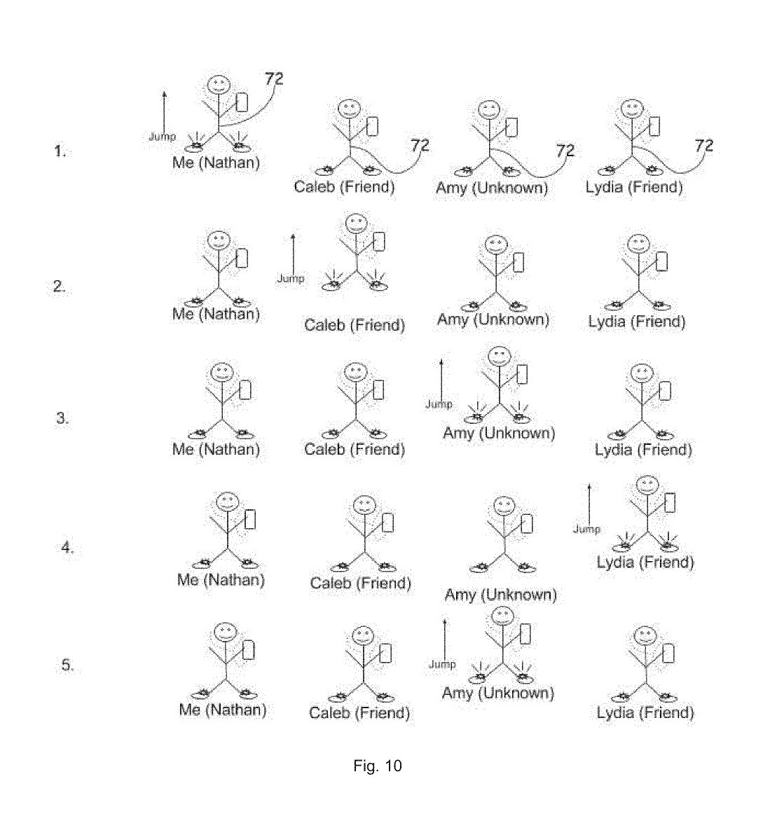

One aspect of the invention that is important is the ability to pair the game communication assemblies 20, 20′ with a smart device. Referring to FIGS. 7 through 10, an example of a game is illustrated as seen on a screen 100 of a smart device 102. The smart device 102 is shown to have a home button 104, which is presented for illustrative purposes only.

In FIG. 7, a group of players are found to be in such close proximity that they can start a game together. The proximity closeness will depend on the various technologies, but the ANT technology has a general limit of 50 meters. Once the game communication assemblies 20, 20′ are identified, those that wish to play can be selected using the selection button 106.

Once the set of players 72 have been identified, a game can be selected. Using the smart device 102, a number of game options can be listed. Referring to FIG. 8, a selection from a listing of games 110 can be made. It should be appreciated by those skilled in the art that the list of games may include any number of games. If needed, an instruction set for the games may be provided (not shown in the Figures).

Referring to FIG. 9, the game communication assembly 20, 20′ may require the players 72 to configure themselves in a particular order. If this is required, it will be shown on the smart device screen as shown, for example, in FIG. 9. Once the players 72 are in the correct order, one of the players 72 can press the “READY” button 112.

The circle jump rope game is illustrated in FIG. 10 with each of the players 72 being instructed when to jump. The game communication assemblies 20, 20′ may vibrate using the heptic feedback device, it may illuminate the LEDs 40, 40′ or it may generate a noise through the speaker 59. The game communication assembly 20, 20′ that signals its user to jump will use the motion sensor device 42 to confirm that the player 72 moved within a predefined time period. If so, the player 72 continues. If not, the player 72 that did not move will be penalized or will be out of the game.

Referring now to FIGS. 11a and 11b, side-by-side views of a pseudo-virtual reality game as seen on a smart device and as seen in real life are shown, respectively. For purposes of this discussion, pseudo-virtual reality is a game involving one or more players were the movement and actions of the players and their respective appendages are incorporated into the game. The pseudo-virtual reality game may or may not impose itself onto the surroundings of the player(s).

Referring specifically to FIG. 11a, a player 72 is represented in the smart device scene depiction 115 as a character 114. The game being played requires the player 113 (seen in FIG. 11b), through the character 114, to interact with a game-generated opponent 118. The player 113 controls the movement of the character 114 and watches the scene unfold on his or her smart device 116, shown to be held in the left hand of the player 113. The player 113 is shown to be wearing to game communication devices 20, 20′; one 20, 20′ on his right hand and another 20, 20′ on his right shoe 122. The game communication devices 20, 20′ worn by the player 113 work in concert to create the movements of the character 114 as it interacts with the game-generated opponent 118.

Referring now to FIG. 11b, the player 113 is shown with the game-generated opponent shown in phantom 119 for reference. It should be understood that other placements and configuration of the smart device and game communications assembly can exist. For example, the user 113 could, with the aid of a virtual reality headset device, wear the smart device on the head and hold a game communication assembly 20, 20′ in each hand. In current versions of some games, the character 114 is controlled with swipe and tapping motions on the screen of the smart device 116. The invention can enhance this game play, increasing the exercise of the user 113 playing the game by replacing the swipe and tapping motions with real hand, feet or other body part motions or gestures. When game communication assembly 20, 20′ attached to an article of clothing, a body part of held in the hand, it can communicate motion information to control the user's character 114. Additionally, the game communication assembly 20, 20′ has the ability to communicate this motion information with other game communication assemblies 20, 20′ attached to another player 120 of the game within RF proximity so that more than one user can share real time motion information in one game. Using the ANT protocol, the game communication assembly 20, 20′ can share motion information with other game communication assemblies and multiple smart devices involved in gameplay with latencies less than the existing method of using the internet connectivity of the smart device to enable multiple players to interact in one fight scene. The game communications assembly 20, 20′ also provides the additional benefit of removing the need for cellular or WiFi communications to enable multiplayer gameplay.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for coordinating a game for a plurality of players wearing a game communication assembly, the method comprising the steps of:
receiving a first unique identifier from a first game communication assembly when one of the plurality of players is in range of a second game communication assembly
transmitting a second unique identifier from the second game communication assembly to the first game communication assembly to initiate bidirectional communication;
establishing a game environment for the plurality of players to play; and
communicating through the first and second game communication assemblies to play the game.

2. A method as set forth in claim 1 including the step of inputting commands into the game communication assemblies to progress the game.

3. A method as set forth in claim 1 including the step of inputting values into the game communication assemblies to progress the game.

4. A method as set forth in claim 3 wherein the step of inputting commands includes creating inputs by having one of the plurality of players physically move at least a portion of a body of the one of the plurality of players.

5. A method as set forth in claim 1 including the step of linking each of the first and second game communication assemblies with a smart device to enhance controls and commands of the game communication assemblies.

6. A method as set forth in claim 1 including the step of adding new players to the plurality of players as new game communication assemblies become local to the first and/or second game communication assemblies.

7. A method as set forth in claim 3 including the step of syncing the command and values inputs across all of the game communication assemblies in real time such that any one of the plurality of players may leave the game without affecting any remaining players of the plurality of players from completing the game.

8. A game communication assembly comprising:
a sensor to sense a parameter and create a sensor signal;
an electronic control unit electrically connected to said sensor to receive the sensor signal and to output a command signal;
a transceiving unit electrically connected to said electronic control unit to receive the command signal and to transmit the command signal remote from said game communication assembly.

9. A game communication assembly as set forth in claim 8 wherein said sensor is a gyroscope.

10. A game communication assembly as set forth in claim 8 wherein said sensor is an accelerometer.

11. A game communication assembly as set forth in claim 8 wherein said sensor is a magnetometer.

12. A game communication assembly as set forth in claim 8 including a housing having a fastener to fasten said game communication assembly to an article of clothing.

13. A game communication assembly as set forth in claim 12 including a lighting unit electrically connected to said electronic control unit to emit light out from said housing.

14. A game communication assembly as set forth in claim 12 including a chord extending out of said housing.

15. A game communication assembly as set forth in claim 14 including a string of LEDs embedded in said chord.

16. A game communication assembly as set forth in claim 15 wherein said chord is translucent allowing light emitted by said string of LEDs pass through said chord.
